(19) United States
(12) Patent Application Publication
(10) Pub. No.: US 2003/0088360 A1
(43) Pub. Date: May 8, 2003

(54) Flight-management computer smoothing an aircraft path over several sequences

(76) Inventors: Yann Ikhlef, Boulogne Billancourt (FR); Patrick Daouphars, Versailles (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/169,079

(22) PCT Filed: Dec. 28, 2000
(86) PCT No.: PCT/FR00/03725

(30) Foreign Application Priority Data
Jan. 7, 2000 (FR) 00 00155

(51) Int. Cl. G01C 21/26

(52) U.S. Cl. 701/202

(57) ABSTRACT

The computer according to the present invention makes it possible to compute the transitions between the legs of an aircraft flight plan without discontinuity of trajectory on the basis of the aircraft manufacturer's routines for computing standardized transitions, doing so over an unlimited number of legs. The reliability of the computer is greatly increased thereby.

The present invention relates to flight computers on board aircraft.

Flight computers (flight management computers or FMCs) allow the automatic steering of aircraft. In a first step, the computations performed on the basis of the standardized data (ARINC 424 standard) regarding the course to be followed generate a flight plan consisting of a series of segments, termed “legs”, making it possible to connect a start point to a finish point. The sequences of legs are themselves standardized. In a second step, curvilinear transitions from one segment to another of the flight plan are computed by taking into account, as appropriate, the flight parameters supplied by the onboard sensors, so as to form a smooth trajectory which minimizes the discomfort imposed on the passengers of the aircraft and the loads on its structures. Aircraft manufacturers have created their own standards which define a limited number of transitions applicable to the sequences of legs of the ARINC standards. However, in numerous configurations, the computers normally generate discontinuities in the transitions, such as overlaps or breaks in trajectory, which it is vital to eliminate.

Various computers making it possible to eliminate these discontinuities have been described, in particular by American patents 3 994 456, 4 354 240 and 5 646 854. These devices take into account a maximum of only three consecutive legs, rely on computations of transitions specific to these configurations of legs and not on the transitions corresponding to the standardized sequences of legs and leave a number of unresolved cases which generate errors of the computer.

The computer according to the present invention makes it possible to compute transitions between two nonconsecutive legs, the number of legs skipped being arbitrary, said transitions being chosen among those applied in the absence of any skip of leg. The reliability of the computer is greatly increased thereby.

Accordingly, the invention proposes a device for computing the trajectory of an aircraft of the type comprising a memory module able to store a flight plan, consisting of a series of flight segments connecting a start point and a finish point, these segments, termed “legs”, being defined among a predetermined number of types, and their sequencing being defined among a predetermined set of possibilities, and a trajectory forecasting module, capable of working by sequencing together a legwise computation procedure and an interleg transition computation procedure, chosen among several as a function of first decision rules, as well as of storing at least partially the resulting trajectory elements, this module possessing a special mode of operation in the event of a skip of leg, characterized in that, in this special mode, said module is capable of applying one of said procedures for interleg transition, between two nonconsecutive legs, as a function of second decision rules.

The invention will be better understood and its various characteristics and advantages will emerge from the description which follows of an exemplary embodiment, and its appended figures, of which:

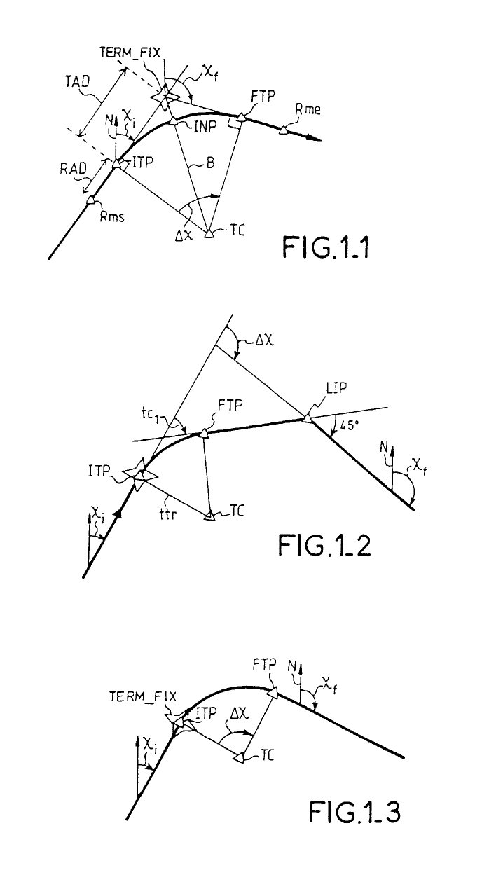

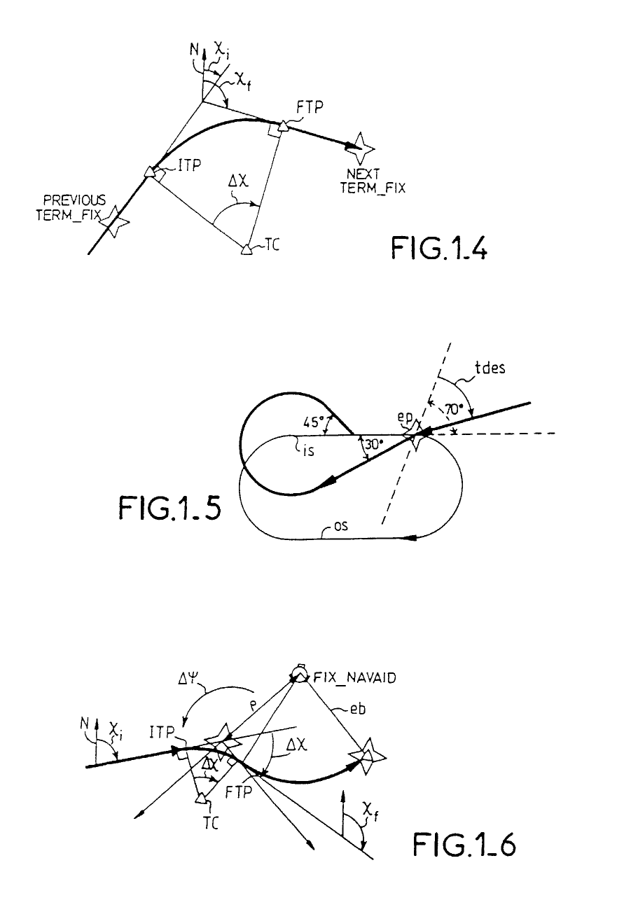

FIG. 1 shows the six standardized types of transition implemented by the computer according to the invention;

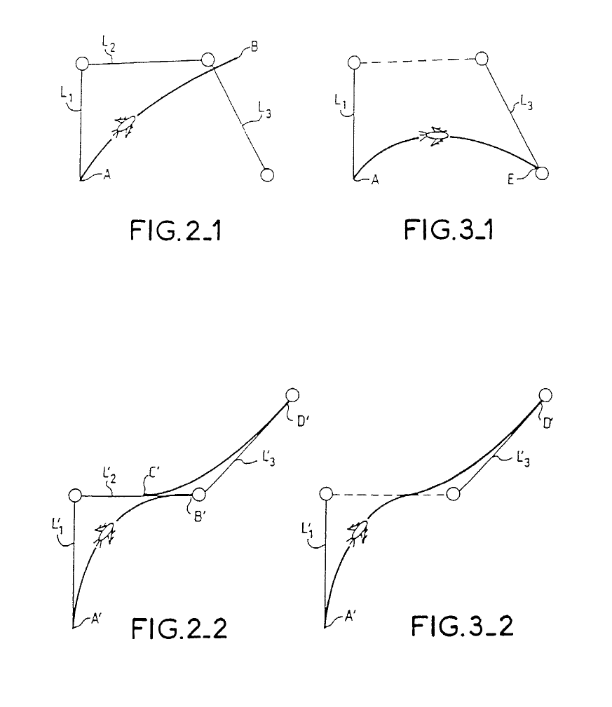

FIG. 2 shows two cases of discontinuity of trajectory for two successive transitions;

FIG. 3 shows how the discontinuities of the previous figure are eliminated by the prior art devices;

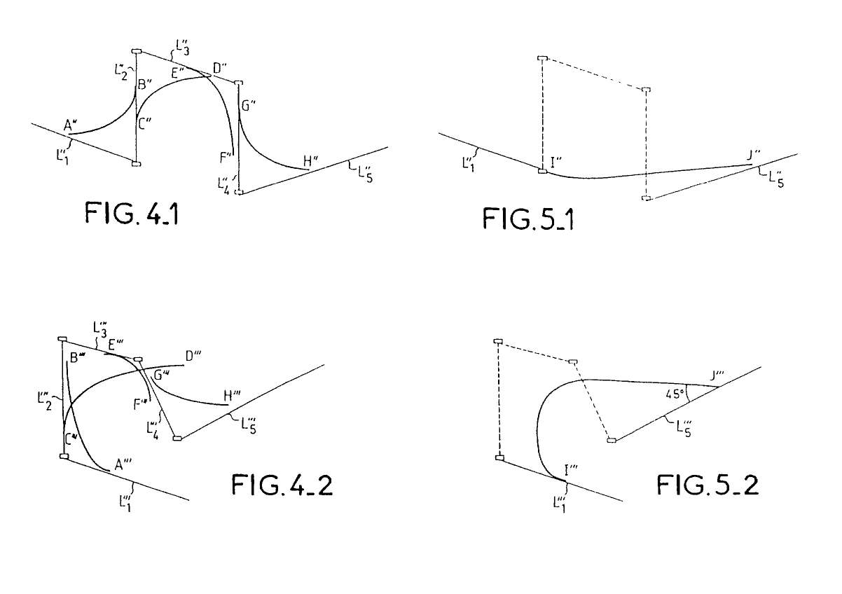

FIG. 4 shows two cases of discontinuities for more than two successive transitions;

FIG. 5 shows how the discontinuities of the previous figure are eliminated by the device according to the invention;

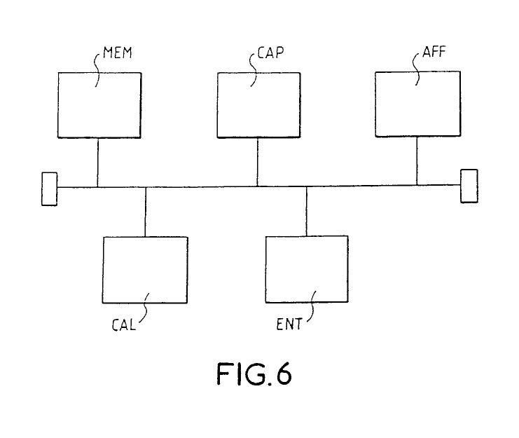

FIG. 6 represents the functional blocks of the computer of the trajectory of an aircraft according to the invention;

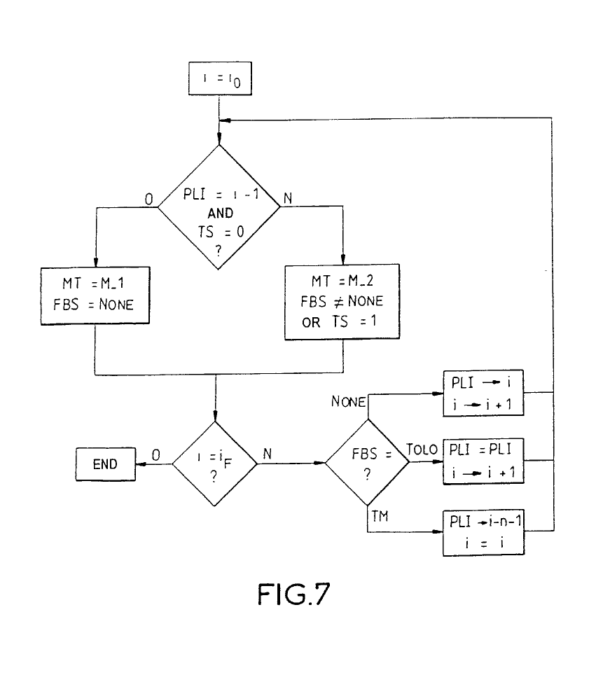

FIG. 7 represents the block diagram of the computation of the trajectory of an aircraft according to the invention.

A flight plan therefore consists of a series of straight portions or “legs” which join an initial point and a terminal point and the sequencing of which makes it possible to connect a start point to a finish point. According to the ARINC 424 standard, the legs may be of twenty-one different types as a function of the characteristics of the initial point and of the terminal point. These standardized types are listed in the table below according to their English names, in which the abbreviation DME stands for “Distance Measuring Equipment”.

| Abbreviation | Meaning |
|---|---|
| AF | DME Arc |
| CA | Course to Altitude |
| CD | Course to DME Distance |
| CF | Course to Fix |
| CI | Course to Intercept |
| CR | Course to Radial |
| DF | Direct to Fix |
| FA | Course from Fix to Altitude |
| FM | Course from Fix to Manual |
| | termination |
| HA | Holding pattern to Altitude |
| HF | Holding pattern to Fix |
| HM | Holding pattern to Manual |
| | termination |
| IF | Initial Fix |
| PI | Procedure Turn |
| RF | Radius to a Fix |
| TF | Track to Fix |
| VA | Heading to Altitude |
| VD | Heading to DME Distance |
| VI | Heading to Intercept |
| VM | Heading to Manual |
| | termination |
| VR | Heading to Radial |

The computed trajectory will consist of the series of flight plan legs connected pairwise by one or more curvilinear portions. Specifically, abrupt changes of heading of an aircraft are neither possible nor desirable. Within the context in which the invention is implemented, six standardized types of transitions have been defined. They are represented in FIGS. 1.1 to 1.6 in which the abbreviations and symbols have the meanings hereinbelow and constitute the parameters required for the computations of the transitions:

common abbreviations: (TERM_FIX)=“fix point”; (PREVIOUS TERM_FIX)=“previous fix point”; (NEXT TERM_FIX)=“next fix point”; (FIX_NAVAID)=“fix beacon”; (TC)=“Turn Center”; (ITP) “Initial Turn Point”; (FTP)=“Final Turn Point”; (N)=“magnetic north”; (χₗ)=“Initial Track”; (χ_{f})=“Final Track”; (Δ_{%})=“Track Variation”;

FIG. 1.1: (Rms)=“Roll maneuver start”; (RAD)=“Roll maneuver Anticipation Distance”; (TAD)=“Turn Anticipation Distance”; (INP)=“Intermediate Point”; (B)=“bisector”; (Rme)=“Roll maneuver end”;

FIG. 1.2: (tcₗ)=“track change 1”; (ttr)=“trans turn radius”; (tLIP)=“trans Leg Intercept Point”;

FIG. 1.5: (tdes)=“tear drop entry sector”; (ep)=“entry point”; (is)=“inbound segment”; (os)=“outbound segment”;

FIG. 1.6: (ρ)=“DME arc”; (Δ_{ψ})=“DME course”; (eb)=“exit bearing”.

When the legs are sufficiently long, the successive transitions are proportional to the legs and the continuity of the trajectory is ensured by a succession of legs and of transitions which do not interfere. However, when the legs are of short distance and form angles of 90° or more between themselves, it is common to see the appearance of configurations similar to those of FIGS. 2.1 and 2.2 which make automatic trajectory computation impossible without supplementary means. In the case of FIG. 2.1, the transition (AB) overshoots the termination of leg L₂. This is also known as a case of “fish”. In this case, it is not possible to compute the next transition by the usual methods. In the case of FIG. 2.2, the terminal point (B′) of the transition (A′B′) lies beyond the initial point (C′) of the next transition (C′D′). This is known as a case of “bird”. These two types of cases are generically called “fish-bird”.

The conventional solution afforded by the prior art (in particular patent U.S. Pat. No. 3,994,456) to situations of this type is to skip the intermediate leg and to compute a direct transition as indicated in FIGS. 3.1 and 3.2. In FIG. 3.1, the leg (L₂) of FIG. 2.1 has been skipped and a single transition (AE) has been computed. Likewise, in FIG. 3.2, the leg (L′₂) of FIG. 2.2 has been eliminated and a single transition (A′D′) has been likewise computed.

This solution does not make it possible to resolve the cases of the type illustrated by FIGS. 4.1 and 4.2 where several successive transitions cause the appearance of fish-birds (case of multiple fish-birds). On the contrary, the present invention allows the implementation of means permitting the skipping of several consecutive legs, as is illustrated in FIGS. 5.1 and 5.2., and the computation of the transition between the last leg not skipped and the first next leg.

In FIG. 4.1, the five legs from L″₁ to L″₅, all of type TF (Track to Fix), would normally be connected by transitions (A″B″) to (G″H″) causing the appearance of three birds (B″ overshoots C″; D″ overshoots E″; F′″ overshoots G′″). According to the prior art, the leg L″₂ is skipped and the transition between L″₁ and L″₃ is computed, then the standard procedure would be that the leg L″4 would be skipped and the transition between L″3 and L″5 would be computed. However, in this case there is no means of preventing the series of the two transitions L″₁ L″₃ and L″₃ L″₅ from generating a discontinuity. The computer will therefore be in error and the pilot will have to take over the controls. As illustrated in FIG. 5.1, the invention makes it possible to skip legs L″₂, L″₃ and L″₄ and to compute the direct transition from L″₁ to L″₅ via the segment (I″J″) which is a transition of type II. Another illustration of the benefit of the invention is provided by FIGS. 4.2 and 5.2. In FIG. 4.2 is depicted another configuration of five legs TF generating two birds ((BB′″) overshoots (C′″) and (F′″) overshoots (G′″)) and a fish (D′″overshoots the termination of the leg L′″₃). The trajectory according to the invention, illustrated in FIG. 5.2 is also computed by skipping three legs, the first and the fifth leg being connected directly by a transition (A′″L′″), also of type II.

The computer according to the invention will normally be composed, as illustrated in FIG. 6, of a storage module (MEM) making it possible to store the data of the flight plan, of a computation module (CAL), of a device for the acquisition and processing of the data supplied by the flight sensors (CAP), such as heading, altitude, speed, distance with respect to a DME benchmark among others, of a module for manual data entry by a pilot or navigator (ENT), such as a keypad among others, a module for displaying the flight plan and trajectory data for the pilot or the navigator (AFF).

The computation module according to the invention can in particular comprise a processor of the Power PC or TMS320C31 or C34 type and various memory stages and passive components. It will be possible to replace this module with any other computation module capable of performing a complete computation of trajectory according to the standard, i.e. for two hundred legs maximum, in five seconds or less.

The functional organization of the means which form the subject of the present invention is illustrated in the block diagram of FIG. 7. These means consist of a computer program whose technical purpose is in particular to allow the computation of the trajectory of the aircraft over the entire flight plan and hence to eliminate all the cases of fish-bird, single or multiple.

Consider the following definitions:

i, the index of the current leg;

PLI, the Previous Leg Index or index of the last leg not skipped;

MT, the matrix for choosing the transitions as a function of the cases of sequencing of the legs;

MT can take two values M_{—}1 and M_{—}2;

FBS, the Fish-Bird Status which can take the values “NONE” when there are no fish-birds, “TOLO” or “Trans Onto Leg Overshoot” in the “fish” case illustrated by FIG. 2.1, “TM” or “Trans Merge” in the “bird” case illustrated by FIG. 2.2;

TS is a logical state indicator which makes it possible to distinguish the cases where specific processing must be applied TS=1;

n is the number of legs skipped since the last leg not skipped.

On initializing the computer, i is fixed at the value i₀ which designates the first leg over which computations are possible, i.e. as a general rule, the leg immediately following the active leg, that is to say the leg traversed by the aircraft at this moment. A test is then applied to PLI and TS. If PLI=i−1 AND TS=0, on the one hand, the last leg not skipped is the leg preceding the current leg, that is to say that no case of fish-bird has been detected FBS=NONE and on the other hand that there is no specific processing to be applied. The transition between the previous leg and the current leg must be chosen from a matrix M_{—}1 such as that given hereinbelow, where the headers of the rows j and of the columns k are the abbreviations of the legs of the ARINC 424 standard and the values appearing in the boxes of the matrix are the serial numbers from I to VI of the types of transitions of FIG. 1, the symbol (*) indicating the impossible sequencings and the letter (D) a compulsory discontinuity defined by ARINC.

| | K | 1 | 2 | 3 | 4 | 5 | 6 | 7 | 8 | 9 | 10 | 11 | 12 | 13 | 14 | 15 | 16 | 17 | 18 | 19 | 20 | 21 |
|---|---|---|---|---|---|---|---|---|---|---|---|---|---|---|---|---|---|---|---|---|---|---|
| J | | AF | CA | CD | CF | CI | CR | DF | FA | FM | HA | HF | HM | IF | PI | RF | TF | VA | VD | VI | VM | VR |
| 1 | AF | VI | III | III | I | III | III | * | I | I | V | V | V | * | * | II | * | III | III | III | III | III |
| 2 | CA | * | III | III | II | III | III | IV | II | II | * | * | * | D | * | * | * | III | III | III | III | III |
| 3 | CD | VI | III | III | II | III | III | IV | II | II | * | * | * | D | * | * | * | III | III | III | III | III |
| 4 | CF | VI | III | III | I | III | III | IV | I | I | V | V | V | * | I | II | I | III | III | III | III | III |
| 5 | CI | VI | * | * | IV | * | * | * | IV | IV | * | * | * | D | * | * | * | * | * | * | * | * |
| 6 | CR | * | III | III | II | III | III | IV | II | II | * | * | * | D | * | * | * | III | III | III | III | III |
| 7 | DF | VI | III | III | I | III | III | IV | I | I | V | V | V | * | I | * | I | III | III | III | III | III |
| 8 | FA | * | III | III | II | III | III | IV | II | II | * | * | * | * | * | * | * | III | III | III | III | III |
| 9 | FM | * | III | III | II | III | III | IV | II | II | * | * | * | * | * | * | * | III | III | III | III | III |
| 10 | HA | VI | III | III | II | III | III | IV | II | II | * | * | * | * | * | II | II | III | III | III | III | III |
| 11 | HF | VI | III | III | II | III | III | IV | II | II | * | * | * | * | * | II | II | III | III | III | III | III |
| 12 | HM | VI | III | III | II | III | III | IV | II | II | * | * | * | * | * | II | II | III | III | III | III | III |
| 13 | IF | D | D | D | D | D | D | D | D | D | D | D | D | * | D | * | D | D | D | D | D | D |
| 14 | PI | * | * | * | II | * | * | * | * | * | * | * | * | * | * | * | * | * | * | * | * | * |
| 15 | RF | VI | III | III | II | III | III | * | II | II | V | V | V | * | * | II | II | * | * | * | * | * |
| 16 | TF | VI | III | III | I | III | III | * | I | I | V | V | V | D | I | II | I | III | III | III | III | III |
| 17 | VA | * | III | III | II | III | III | IV | II | II | * | * | * | D | * | * | * | III | III | III | III | III |
| 18 | VD | VI | * | * | IV | * | * | * | IV | IV | * | * | * | D | * | * | * | * | * | * | * | * |
| 19 | VI | VI | III | III | II | III | III | IV | II | II | * | * | * | D | * | * | * | III | III | III | III | III |
| 20 | VM | * | III | III | II | III | III | IV | II | II | * | * | * | D | * | * | * | III | III | III | III | III |
| 21 | VR | * | III | III | II | III | III | IV | II | II | * | * | * | D | * | * | * | III | III | III | III | III |

If PLI≠i−1 OR TS=1, either the last leg has been deleted, that is to say FBS≠NONE, or a specific processing must be applied. In both cases, the value of the transition to be applied is given by box m_{—}2_{j,k} of the matrix M_{—}2 appearing at the intersection of row j whose header is equal to the type of the last leg not skipped and of column k whose header is equal to the type of the current leg. The matrix M_{—}2 will be of the type given below.

| | K | 1 | 2 | 3 | 4 | 5 | 6 | 7 | 8 | 9 | 10 |
|---|---|---|---|---|---|---|---|---|---|---|---|
| J | | AF | CA | CD | CF | CI | CR | DF | FA | FM | HA |
| 1 | AF | II | II | II | II | II | II | II | II | II | TS₃ |
| 2 | CA | II | III | III | II | III | III | IV | II | II | TS₃ |
| 3 | CD | II | III | III | II | III | III | IV | II | II | TS₂ |
| 4 | CF | II | II | II | II | II | II | II | II | II | TS₃ |
| 5 | CI | II | III | III | II | III | III | IV | II | II | TS₃ |
| 6 | CR | II | III | III | II | III | III | IV | II | II | TS₃ |
| 7 | DF | II | II | II | II | II | II | II | II | II | TS₃ |
| 8 | FA | II | III | III | II | III | III | IV | II | II | TS₃ |
| 9 | FM | II | III | III | II | III | III | IV | II | II | TS₃ |
| 10 | HA | II | III | III | II | III | III | IV | II | II | TS₃ |
| 11 | HF | II | II | II | II | II | II | II | II | II | TS₃ |
| 12 | HM | II | III | III | II | III | III | IV | II | II | TS₃ |
| 13 | IF | TS | TS₁ | TS₁ | TS₁ | TS | TS₁ | TS₁ | TS₁ | TS₁ | TS₁ |
| 14 | PI | * | * | * | TS₁ | * | * | * | * | * | * |
| 15 | RF | II | II | II | II | II | II | II | II | II | TS₃ |
| 16 | TF | II | II | II | II | II | II | II | II | II | TS₃ |
| 17 | VA | II | III | III | II | III | III | IV | II | II | TS₃ |
| 18 | VD | II | III | III | II | III | III | IV | II | II | TS₃ |
| 19 | VI | II | III | III | II | III | III | IV | II | II | TS₃ |
| 20 | VM | II | III | III | II | III | III | IV | II | II | TS₃ |
| 21 | VR | II | III | III | II | III | III | IV | II | II | TS₃ |
| | 11 | 12 | 13 | 14 | 15 | 16 | 17 | 18 | 19 | 20 | 21 |
| J | HF | HM | IF | PI | RF | TF | VA | VD | VI | VM | VR |
| 1 | TS₃ | TS₃ | TS₂ | II | II | II | III | III | III | III | III |
| 2 | TS₂ | TS | TS₂ | II | II | II | III | III | III | III | III |
| 3 | TS₃ | TS₂ | TS₂ | II | II | II | III | III | III | III | III |
| 4 | TS₃ | TS₃ | TS₂ | II | II | II | III | III | III | III | III |
| 5 | TS₃ | TS₂ | TS₂ | II | II | II | III | III | III | III | III |
| 6 | TS₃ | TS₃ | TS₂ | II | II | II | III | III | III | III | III |
| 7 | TS₃ | TS₃ | TS₂ | II | II | II | III | III | III | III | III |
| 8 | TS₂ | TS₃ | TS₂ | II | II | II | III | III | III | III | III |
| 9 | TS₃ | TS₃ | TS₂ | II | II | II | III | III | III | III | III |
| 10 | TS₃ | TS₃ | TS₂ | II | II | II | III | III | III | III | III |
| 11 | TS₃ | TS₃ | TS₂ | II | II | II | III | III | III | III | III |
| 12 | TS₃ | TS₃ | TS₂ | II | II | II | III | III | III | III | III |
| 13 | TS₁ | TS₁ | TS₁ | TS₁ | TS₁ | TS₁ | TS₁ | TS₁ | TS₁ | TS₁ | TS₁ |
| 14 | * | * | * | * | * | * | * | * | * | * | * |
| 15 | TS₃ | TS₃ | TS₂ | II | II | II | III | III | III | III | III |
| 16 | TS₃ | TS₃ | TS₂ | II | II | II | III | III | III | III | III |
| 17 | TS₃ | TS₃ | TS₂ | II | II | II | III | III | III | III | III |
| 18 | TS₃ | TS₃ | TS₂ | II | II | II | III | III | III | III | III |
| 19 | TS₃ | TS₃ | TS₂ | II | II | II | III | III | III | III | III |
| 20 | TS₃ | TS₃ | TS₂ | II | II | II | III | III | III | III | III |
| 21 | TS₃ | TS₃ | TS₂ | II | II | II | III | III | III | III | III |

The values m_{—}2_{j,k} are determined in the following manner:

m_{—}2_{j,k}=II when k=1, 4, 8, 9, 14, 15, 16 except when j=13, 14 or when k=2, 3, 5, 6, 7, and j=1, 4, 7, 11, 15, 16;

m_{—}2_{j,k}=III when k≧17 except when j 13, 14, or when k=2, 3, 5, 6 and j=2, 3, 5, 6, 8, 9, 10, 12, 17, 18, 19, 20, 21;

m_{—}2_{j,k}=IV when k=7 and j=2, 3, 5, 6, 8, 9, 10, 12, 17, 18, 19, 20, 21.

The other values of j and of k lead to specific processing or impossible sequencings. In one implementation of the invention, four cases of specific processing can be distinguished:

m_{—}2_{j,k}=TS₁ ∀ k when j=13: regardless of the configuration of the sequencing, the current leg will not be skipped; the start point of the transition to the current leg precedes the point of termination of the last leg not skipped, which is a fix; the transition degrades down to type II onwards of the termination of the current leg which will automatically be overflown;

m_{—}2_{j,k}=TS₂ ∀ j when k=13: regardless of the configuration of the sequencing, the last leg not skipped will not be skipped; the transition is retained as is even if it overshoots the point of termination of the current leg;

m_{—}2_{j,k}=TS₃ ∀ j when 10≦k<13: regardless of the configuration of the sequencing, the last leg not skipped will not be skipped and a direct interception is constructed up to the point of entry of the “hold”, the current leg being transformed into a leg of type DF “Direct to Fix”;

m_{—}2_{j,k}=TS₄ when j=14 and k=4: regardless of the configuration of the sequencing, the current leg will not be skipped and nothing is modified.

The cases j=14 and k≠4 correspond to impossible sequencings: a leg PI is necessarily followed by a leg CF; neither the flight plan computer nor the pilot can impose a different configuration.

Whether the matrix for choosing the transitions be M_{—}1 or M_{—}2, a test is then carried out as to whether the index of the current leg is pointing to the last leg of the flight plan. If such is not the case, then FBS is tested so as to compute the new values to be applied to the indices i of the current leg and PLI of the last leg not skipped for the next loop of the computation. Three cases are possible:

in the case where FBS=NONE, the two indices i and PLI are increased by 1;

in the case where FBS=TOLO, the index PLI is not modified and the index i is increased by 1;

in the case where FBS=TM, the index PLI is reset to the last value i−n−1 of PLI not skipped.

The present invention makes it possible to very considerably reduce the number of cases where the computer will generate an error, the pilot then having to plot the trajectory in manual mode. Of course, this last possibility is always open when it is necessary or appears to be more advantageous.

The invention can be implemented before takeoff so as to compute a mission preparation trajectory or in-flight to compute a trajectory dynamically, on the basis of the flight plan stored before takeoff or on the basis of any flight plan recomputed during the conduct of the mission.

The invention can be implemented in various versions of the ARINC 424 standard and adapt without difficulty to future upgrades thereof. This will be the case in particular in respect of the “Required Navigation Performance” or RNP procedures which define limit zones not to be overshot around the leg. Such is also the case should there be alterations to the typical transitions applied according to the aircraft manufacturer's specifications to the sequencing of the standardized legs. In both these cases, the matrix M_{—}1 and/or the matrix M_{—}2 will be modified accordingly, as will, if necessary, the routines for computing the transitions which are called upon as a function of the application of the decision matrices.

It is also possible to adapt the invention to a number of cases of computation of index greater than three, should this appear to be necessary.

It is also possible to envisage more than two decision matrices.

Likewise, should it be necessary to manage more than two indices in parallel, at least in certain cases, it is possible to envisage decision matrices having as many dimensions as indices to be managed.

1. A device for computing the trajectory of an aircraft of the type comprising a memory module (MEM) able to store a flight plan, consisting of a series of flight segments connecting a start point and a finish point, these segments, termed “legs”, being defined among a predetermined number of types, and their sequencing being defined among a predetermined set of possibilities, and a trajectory forecasting module (CAL), capable of working by sequencing together a legwise computation procedure and an interleg transition computation procedure, chosen among several as a function of first decision rules M_{—}1, as well as of storing at least partially the resulting trajectory elements, this module possessing a special mode of operation in the event of a skip of leg, characterized in that, in this special mode, said module is capable of applying one of said procedures for interleg transition, between two nonconsecutive legs, as a function of second decision rules M_{—}2.

2. The device as claimed in the preceding claim, characterized in that said module is capable of discriminating irregular interleg configurations in which it can take said special mode by iteratively performing leg skips whenever an undesirable configuration is re-encountered.

3. The device as claimed in one of the preceding claims, characterized in that it is capable of computing and of storing the indices i of the current leg and PLI of the last leg not skipped, said computation being such that, if the previous leg has not been skipped, i is increased by one unit and PLI is set to i, if the previous leg has been skipped due to generating a transition culminating beyond the terminal point of the current leg, i is increased by one unit and PLI is not modified and if the previous leg has been modified due to generating a transition culminating beyond the initial point of the current leg, i is not modified and PLI is reset to the index of the last leg not skipped.

4. The device as claimed in one of the previous claims, characterized in that, when a leg of the flight plan is skipped, the transition which connects the last leg not skipped to the current leg is chosen among three types of solutions numbered from II to IV such that, in the case of type II, the aircraft rejoins the current leg via a straight portion making an angle of 45° with said current leg, the transition between the last leg not skipped and said straight portion consisting of an arc of a circle commencing vertically in line with said last leg not skipped and terminating tangentially to said straight portion, in the case of type III, the aircraft rejoins the heading of the current leg via an arc of a circle commencing at the terminal fixed point of the last leg not skipped and terminating tangentially to the current leg, in the case of type IV, the aircraft rejoins the current leg via an arc of a circle tangential to the last leg not skipped and to the current leg, the choice between said three solutions being effected according to a decision matrix M_{—}2 whose entries in terms of rows of index j and columns of index k consist of the flight plan legs according to the ARINC 424 standard arranged in ascending alphabetical order of said standard, the values m_{—}2_{j,k} of said matrix being m_{—}2_{j,k}=II when k=1, 4, 8, 9, 14, 15, 16 except when j=13, 14, or when k=2, 3, 5, 6, 7 and j=1, 4, 7, 11, 15, 16, m_{—}2_{j,k}=III when k≧17 except when j=13, 14, or when k=2, 3, 5, 6 and j=2, 3, 5, 6, 8 , 9, 10, 12, 17, 18, 19, 20, 21, and m_{—}2_{j,k}=IV when k=7 and j=2, 3, 5, 6, 8, 9, 10, 12, 17, 18, 19, 20, 21, the other values of j and of k requiring specific processing.

5. The device as claimed in claims 3 and 4, characterized in that in the specific cases as claimed in claim 4, if j=13, the specific processing TS₁ is applied, that is to say the current leg is retained and the transition is of type II from the point of termination of the current leg, if k=13, the specific processing TS₂ is applied, that is to say the last leg not skipped is retained as is the transition computed, if k=10, 11, 12, the specific processing TS₃ is applied, that is to say the last leg not skipped is retained and connected directly to the start point of the current leg which is transformed into a “Direct to Fix” leg, and if j=14 and k=4, the specific processing TS₄ is applied, that is to say the current leg is retained.
